(19) United States
(12) Patent Application Publication
(10) Pub. No.: US 2006/0015773 A1
(43) Pub. Date: Jan. 19, 2006

(54) System and method for failure recovery and load balancing in a cluster network

(75) Inventors: Sumankumar A. Singh, Pflugerville, TX (US); Mark D. Tibbs, Austin, TX (US)

Correspondence Address: Roger Fulghum;Baker Botts L.L.P., One Shell Plaza, 910 Louisiana Street, Houston, TX, 77002-4995, US

(73) Assignee: DELL PRODUCTS L.P.

(21) Appl. No.: 10/892,761

(22) Filed: Jul. 16, 2004

(51) Int. Cl. G06F 11/00

(52) U.S. Cl. 714/13

(57) ABSTRACT

A system and method for failure recovery in a cluster network is disclosed in which each application of each node of the cluster network is assigned a preferred failover node. The dynamic selection of a preferred failover node for each application is made on the basis of the processor and memory requirements of the application and the processor and memory usage of each node of the cluster network.

### TECHNICAL FIELD

The present disclosure relates generally to the field of networks, and, more particularly, to a system and method for failure recovery and load balancing in a cluster network.

### BACKGROUND

As the value and use of information continues to increase, individuals and businesses continually seek additional ways to process and store information. One option available to users of information is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may also vary with regard to the kind of information that is handled, how the information is handled, how much information is processed, stored, or communicated, and how quickly and efficiently the information may be processed, stored, or communicated. The variations in information handling systems allow for information handling systems to be general or configured for a specific user or specific use, including such uses as financial transaction processing, airline reservations, enterprise data storage, or global communications. In addition, information handling systems may include a variety of hardware and software components that may be configured to process, store, and communicate information and may include one or more computer systems, data storage systems, and networking systems.

Computers, including servers and workstations, are often grouped in clusters to perform specific tasks. A server cluster is a group of independent servers that is managed as a single system and is characterized by higher availability, manageability, and scalability, as compared with groupings of unmanaged servers. A server cluster typically involves the configuration of a group of servers such that the servers appear in the network as a single machine or unit. Server clusters often share a common namespace on the network and are designed specifically to tolerate component failures and to support the transparent addition or subtraction of components in the cluster. At a minimum, a server cluster includes two servers, which are sometimes referred to as nodes, that are connected to one another by a network or other communication links.

In a high availability cluster, when a node fails, the applications running on the failed node are restarted on another node in the cluster. The node that is assigned the task of hosting a restarted application from a failed node is often identified from a static list or table of preferred nodes. The node that is assigned the task of hosting the restarted application from a failed node is sometimes referred to as the failover node. The identification of a failover node for each hosted application in the cluster is typically determined by a system administrator and the assignment of failover nodes to applications may be made well in advance of an actual failure of a node. In clusters with more than two nodes, identifying a suitable failover node for each hosted application is a complex task, as it is often difficult to predict the future utilization and capacity of each node and application of the network. It is sometimes the case that, at the time of a failure of a node, the assigned failover node for a given application of the failed node will be at or near its processing capacity and the task of hosting of an additional application by the identified failover node will necessarily reduce the performance of other applications hosted by the failover node.

### SUMMARY

In accordance with the present disclosure, a system and method for failure recovery in a cluster network is disclosed in which each application of each node of the cluster network is assigned a preferred failover node. The dynamic selection of a preferred failover node for each application is made on the basis of the processor and memory requirements of the application and the processor and memory usage of each node of the cluster network.

The system and method disclosed herein is advantageous because it provides for load balancing in multi-node cluster networks for applications that must be restarted in a node of the network following the failure of another node in the network. Because of the load balancing feature of the system and method disclosed herein, an application from a failed node can be restarted in a node that has the processing capacity to support the application. Conversely, the application is not restarted in a node that is operating near its maximum capacity at a time when other nodes are available to handle the application from the failed node. The system and method disclosed herein is advantageous because it evaluates the load or processing capacity that is present on a potential failover node before assigning to that node the responsibility for hosting an application from a failed node.

Another technical advantage of the present invention is that the load balancing technique disclosed herein can select a failover node according to an optimized search criteria. As an alternative to assigning the application to the first node that is identified as having the processing capacity to host the application, the system and method disclosed herein is operable to search for the node among the nodes of the cluster network that has the most available processing capacity. Another technical advantage of the system and method disclosed herein is that the load balancing technique disclosed herein can be automated. Another advantage of the system and method disclosed herein is that the load balancing technique can be applied in a node in advance of the failure of the node and a time when the processor usage in the node meets or exceeds a defined threshold value. Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a diagram of a cluster network;

FIG. 1A is depiction of a first portion of a decision table;

FIG. 1B is a depiction of a second portion of a decision table;

FIG. 2 is a diagram of the flow of data between modules of the cluster network;

FIG. 3 is a flow diagram for identifying a preferred failover node for each application of a node; and

FIG. 4 is a flow diagram for balancing the processor loads on each node of the cluster network.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components. An information handling system may comprise one or more nodes of a cluster network.

Enclosed herein is a dynamic and self-healing recovery failure technique for a cluster environment. The system and method disclosed herein provides for the intelligent selection of failover nodes for applications hosted by a failed node of a cluster network. In the event of a node failure, the applications hosted by the failed node of the cluster network are assigned or failed over to the selected failover node. A failover node is dynamically preassigned for each application of each node of the cluster network. The failover nodes are selected on the basis of the processing capacity of the operating nodes of the network and the processing requirements of the applications of the failed node. Upon the failure of a node of the cluster network, each application of the failed node is restarted on its dynamically preassigned failover node.

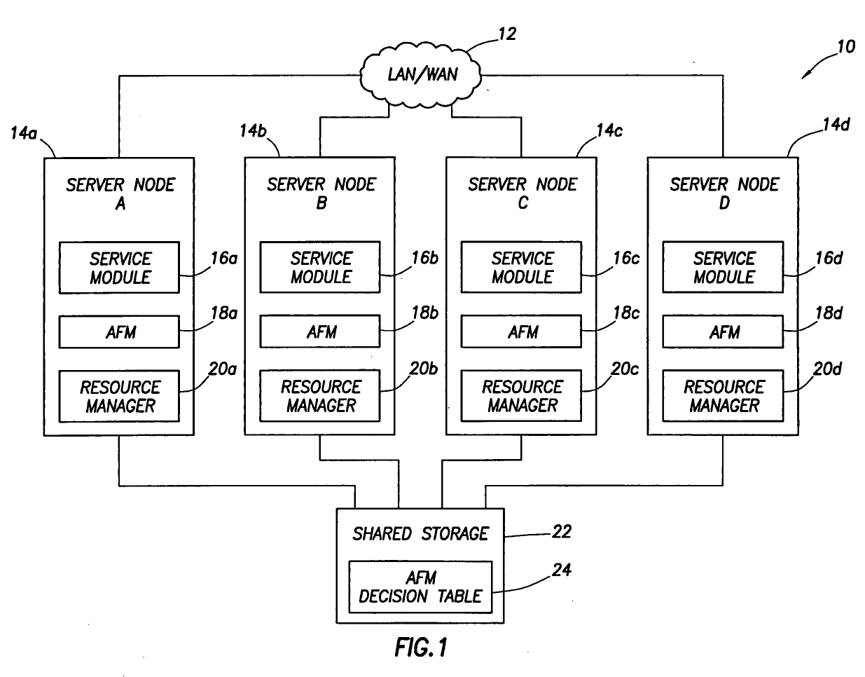

Shown in FIG. 1 is a diagram of a four-node server cluster network, which is indicated generally at 10. Cluster network 10 is an example of an implementation of a highly available cluster network. Server cluster network 10 includes a LAN or WAN node 12 that is coupled to each of four server nodes, which are identified as server nodes 14a, 14b, 14c, and 14d. Each server node 14 hosts one or more software applications, which may include file server applications, print server applications, and database applications, to name just a few of the variety of application types that could be hosted by server nodes 14. In addition to hosting one or more software applications, each of the server nodes include modules for managing the operation of the cluster network and the failure recovery technique disclosed herein. Each server node 14 includes a service module 16, an application failover manager (AFM) 18, and a resource manager 20. Each of the service modules 16, application failover managers 18, and resource managers 20 includes a suffix (a, b, c, or d) to associate the modules with the server node having the like alphabetical designation. Each service module 16 monitors the status of its associated node and the applications of the node. In the event of the failure of the node, server module 16 identifies this failure to the other cluster servers 14 and transfers responsibility for each hosted application of the failed node to one of the other cluster servers 14.

The resource manager 20 of each node measures the processor and memory usage of each of the applications hosted by the node. Resource manager 20 also measures the collective processor and memory usage of all applications and processes on the node. Resource manager 20 also measures the current processor and memory usage of each application on the node. Resource manager 20 also identifies and maintains a record of the processor and memory utilization requirements of each application hosted by the node. Each application failover manager 18 of each node receives from resource manager 20 (and via an application failover manager decision table on shared storage) information concerning the processor and memory usage of each node; information concerning the processor and memory usage of each application on the node; and information concerning the processor and memory utilization requirements of each application on the node. With this information, the application failover manager is able to identify on a dynamic basis for service module 16 a failover node for each application hosted at the node. For each application of the node, failover manager 18 is able to identify, as a failover node, the node of the cluster network that has the maximum amount of available processor and memory resources.

Each server node 14 is coupled to shared storage 22. Shared storage 22 includes an application failover manager decision table 24. Application failover manager decision table 24 is a data structure stored in shared storage 22 that includes data reflecting the processor and memory usage of each node and the processor and memory utilization requirements of each application of each server node of the cluster network. Shown in FIG. 1A is a portion of the decision table 24 that depicts processor usage and memory usage for each of the four server nodes of the cluster network. For each node, the processor usage value of the table of FIG. 1A is the most recent measure of the processor resources of the node that are actively being consumed by the applications and other processes of the node. Similarly, the memory usage value of the table is the most recent measure of the memory resources of the node that are actively being consumed by the applications and other processes of the node. The processor usage value and the memory usage value are periodically reported by each resource manager 20 to the application failover manager decision table 24. As such, each resource manager 20 takes a periodic measurement or snapshot the processor usage and memory usage of the node and reports this data to application failover manager decision table 24, where it used to populate the table of FIG. 1A. The processor availability value of the table of FIG. 1A represents the maximum threshold value of processor resources in the node less the processor usage value. As such, the processor availability value is a measure of the unused processor resources of a particular node of the cluster network. The memory availability value of the table of FIG. 1A represents the maximum threshold value of memory usage in the node less the memory usage value. The memory availability value is a measure of the unused memory recourses of the node. Shown in FIG. 1B is a portion of the application failover manager decision table 24 that identifies, for each application in the cluster network, the processor and memory utilization requirements for the application.

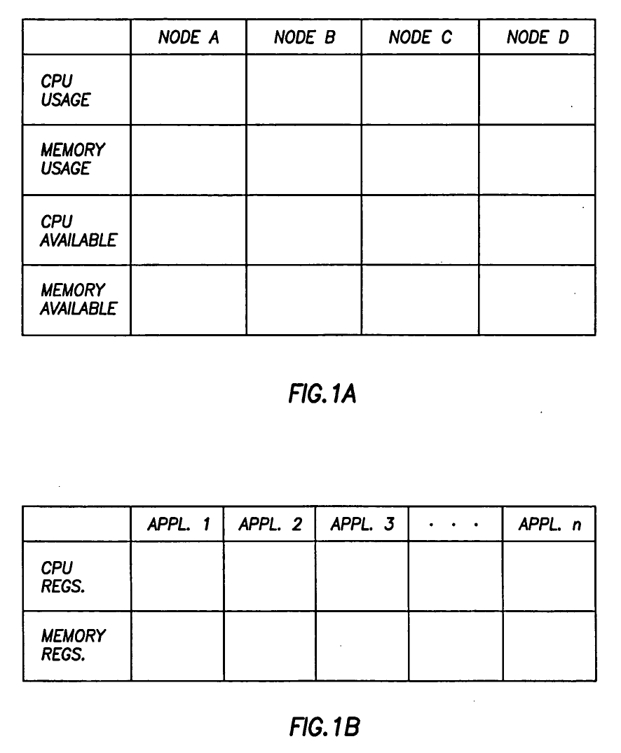

The content of the application failover manager decision table 24 is provided by the resource manager 20 of each server node 14. On a periodic basis, resource manager 20 of each node writes to the application failover manager decision table to update the processor and memory usage of the node and the processor and memory requirements of each application in the node. Because of the periodic writes to the application failover manager decision table by each node, the application failover manager decision table includes an accurate and recent snapshot of the processor and memory usage and requirements of each node (and the applications in the node) in the cluster network. Application failover manager decision table 24 can also be read by each application failover manager 18. As an alternative to storing AFM decision table 24 in shared storage 22, a copy of the AFM decision table could be stored in each of the server nodes. In this arrangement, an identical copy of the AFM decision table is placed in each of the server nodes. Any modification to the AFM decision table in one of the server nodes is propagated through a network interconnection to the other server nodes. The flow of data between the modules of the system and method disclosed herein is shown in FIG. 2. As indicated in FIG. 2, the resource manager 20 of each node provides data to application failover manager decision table 24 of shared storage. The application failover manager 18 of each node reads data from the application decision table 24 and identifies to service module 16 a preferred failover node for each application of the node.

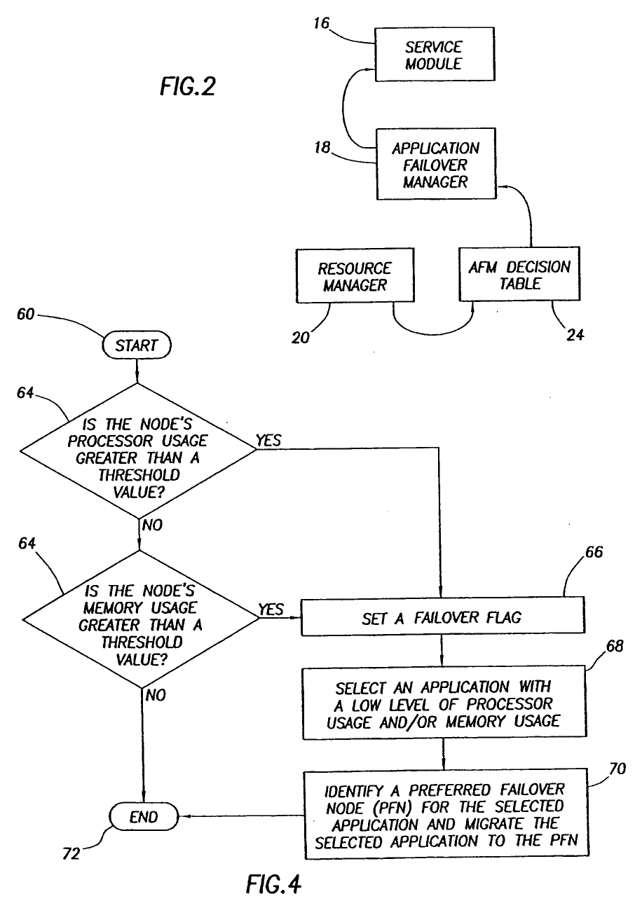

Shown in FIG. 3 are a series of method steps for identifying a preferred failover node for each application of a node. The method steps of FIG. 3 are executed at periodic intervals at each node of the cluster network. In the description that follows, the node that is executing the method steps of FIG. 3 is referred to as the current node. It should be recognized that each node separately and periodically executes the method steps of FIG. 3. The periodic execution by each node of the method steps of FIG. 3 provides for the periodic identification of the preferred failover node of each application of each node. Because the selection of the preferred failover node is done at regular intervals, the process of identifying a preferred failover node for each application of each node is based on recent data concerning the processor and memory usage and requirements of the nodes and applications of the cluster network. Following the initiation of the process of selecting a preferred failover node at step 30, the application failover manager 18 of the node reads at step 32 the application failover manager decision table 24 from shared storage 22. Because the content of the application failover manager decision table 24 is periodically updated by the resource manager 20 of each of the nodes, the decision table reflects the recent usage and requirements of the nodes and applications of the cluster network.

At step 34 of FIG. 3, an application is identified for the assignment of a preferred failover node. At step 36, a copy of the application failover manager decision table is copied from shared storage 22 to a storage location in the current server node so that the decision table is accessible by application failover manager 18. Following the completion of step 36, failover manager 18 has access to a local copy of the decision table. Application failover manager 18 will use this local copy of the decision table for the assignment of a preferred failover node to each application of the node. At step 38, application fallover manager identifies the nodes of the system in which (a) the processor availability of the node is greater than the processor requirements of the selected application, and (b) the memory availability of the node is greater than the memory requirements of the selected application. Each node of the cluster network, with the exception of the current node, is evaluated for the sake of the comparison of step 38. The result of the comparison step is the identification of a set of nodes from among the nodes of the cluster network that have sufficient processor and memory reserves to accommodate the application in the event of a failure of the current node. The set of nodes that satisfy the comparison of step 38 are referred to herein as suitable nodes.

At step 40, it is determined if the number of suitable nodes is zero. If the number of suitable nodes is greater than zero, i.e., the number of suitable nodes is one or more, the flow diagram continues with the selection at step 42 of the suitable node that has the most processor availability. At step 44, the selected node is identified as the preferred failover node for the application. The identification of the preferred failover node may be recorded in a data structured maintained at or by application failover manager 18. The identification of the preferred failover node may also be sent to service module 16 of the node, as the service module of the failed node generally assumes the responsibility of restarting each application of the failed node on the respective failover nodes. If it is determined at step 40 that the number of suitable nodes is zero, processing continues with step 41, where a selection is made of the node (not including the current node) that has the most processor availability. At step 44, the node selected at step 41 is identified as the preferred failover node for the application.

Following the selection of the preferred failover node for the application, the local copy of the application failover manager decision table must be updated to reflect that an application of the current node has been assigned a preferred failover node. Following step 44, a portion of the processor and memory availability of a preferred failover node has been pledged to an application of the current node. The reservation of these resources for this application should be considered when assigning preferred failover nodes for the remainder of the applications of the current node. Each previous assignment of a preferred failover node for an application of the current node is therefore considered when assigning a preferred failover node to any of the remainder of the applications of the current node. If the local copy of the decision table is not updated to reflect previous assignments of preferred failover nodes to applications of the current node, each application of the current node will be considered in isolation, with the possible result that one or more nodes of the cluster network could become oversubscribed as the preferred failover node for multiple applications of the current node. At step 46, the local copy of the application failover manager decision table is updated to reflect the addition of the current processor usage of the assigned application to the processor usage of the preferred failover node. At step 48, the local copy of the decision table is updated to reflect the addition of the current memory usage of the assigned application to the memory usage of the preferred failover node. In sum, the local copy of the decision table is updated with the then current usage of the assigned application. Following steps 46 and 48, the decision table reflects the usage that would likely exist on the preferred failover node following the restarting on that node of those applications that have been assigned to restart or fail over to that node.

At step 50, it is determined if the present node includes additional applications that have not yet been assigned a preferred failover node. If the current node includes applications that have not yet been assigned a preferred failover node since the initiation of the assignment process at step 30, the next following application is selected at step 51, and the flow diagram continues with the comparison step of step 38. The step of selecting an application of the current node for assignment of a preferred failover node may be accomplished according to a priority scheme in which the applications are ordered for selection and assignment of a preferred failover node according to their processor utilization requirements; the application that has the highest processor utilization requirement is selected first for the assignment of a preferred failover node, and the application that has the lowest processor utilization requirement is selected last for assignment. Assigning a priority to those applications that have a higher processor utilization requirement may assist in identifying an application failover node for all applications, as such a selection scheme may avoid the circumstance in which failover assignments for a number of applications having lower utilization requirements are made to various nodes of the cluster network. As a result of these previous assignments, some or all nodes of the cluster network may be unavailable for the assignment of an application of a node having a higher utilization requirement. Placing an assignment priority on those applications having the highest resource utilization manages the allocation of preferred failover nodes in a way that attempts to insure that each application will be assigned to a failover node that is able to accommodate the utilization requirements of the application.

As an alternative to a priority scheme in which the application having the highest processor utilization requirement is selected first for assignment, the applications of a node could be selected for assignment according to a priority scheme that recognizes the business importance of the applications or the risk associated with shutting down or reinitiating the application. The selection of a prioritization scheme for assigning failover nodes to applications of the node may be left to a system administrator. If it is determined at step 50 that all applications of the current node have been assigned a preferred failover node, the process of FIG. 3 ends at step 52.

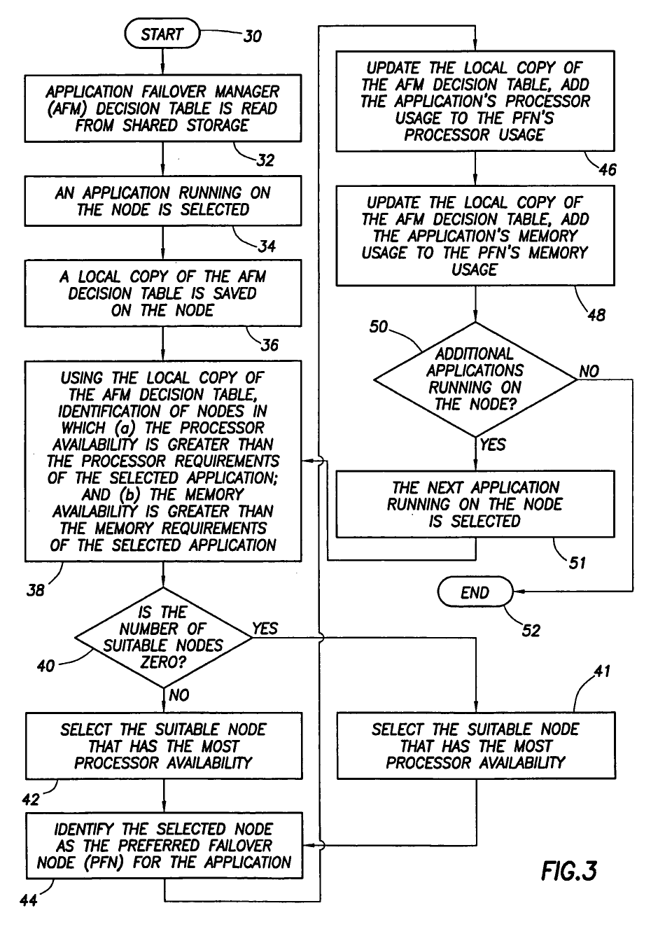

Shown in FIG. 4 is a flow diagram of a method for balancing the processor loads on each node of the cluster network. The method steps of FIG. 4 may be executed with respect to any node of the cluster network. The cluster network may be configured to periodically execute the method steps of FIG. 4 with respect to each node of the cluster network. In addition, the load balancing technique of FIG. 4 could be executed on each node of the cluster network following the failure of another node of the network. In addition, the load balancing technique of FIG. 4 could be triggered to execute at any time when the processor usage or memory usage of a node exceeds a certain threshold. Following the initiation of the load balancing method at step 60, it is determined at step 62 whether the processor usage of the node is greater than a predetermined threshold value. If the processor usage of the node exceeds a threshold value, a failover flag is set at step 66. If the processor usage of the node does not exceed the predetermined threshold value, it is determined at step 64 whether the memory usage of the node is greater than a predetermined threshold value. If the memory usage of the node exceeds a threshold value, a failover flag is set at step 66. If the memory usage of the node does not exceed a threshold value, the process ends at step 72, and it is not necessary to reassign any of the applications of the node.

Following the setting of a failover flag at step 66, an application is selected at step 68. The application that is selected at step 68 is an application with a low level of processor usage or memory usage. The selection step may involve the selection of the application that has the lowest processor usage or the lowest memory usage. As an alternative to selecting the application that has the lowest processor usage or the lowest memory usage, an application could be selected according to a priority scheme in which the application having the lowest priority is selected. The selection of an application for migration to another node will result in the application being down, at least for a brief period. As such, applications that, for business or technical reasons, are required to be up are assigned the highest priority, and applications that are best able to be down for a period are assigned the lowest priority. Once an application is identified, a preferred failover node for the selected application is determined at step 70. The identification of a preferred failover node at step 70 can be performed by the selection process set out in the steps of FIG. 3. Because step 70 of FIG. 4 requires that only a single application be assigned a preferred failover node, steps 50 and 51 of the method of FIG. 3, which insure the assignment of all applications of the node, would not be performed as part of the identification of a preferred failover node. Once a preferred failover node is identified for the selected application, the application is migrated or failed over to the preferred failover node. The process of FIG. 4 could be performed again to further balance the usage of the node.

The system and method described herein may be used with clusters having multiple nodes, regardless of their number. Although the present disclosure has been described in detail, it should be understood that various changes, substitutions, and alterations can be made hereto without departing from the spirit and the scope of the invention as defined by the appended claims.

What is claimed is:

1. A method for identifying a failover node for an application of a multiple node cluster network, comprising the steps of;
selecting an application to be assigned a failover node;
identifying a set of nodes having usage capacity greater than the usage capacity of the selected application;
selecting the node having the most usage capacity from among the set of nodes identified as having a usage capacity greater than the usage capacity of the selected application; and
identifying the selected node as the preferred failover node for the selected application.

2. The method for identifying a failover node for an application of a multiple node cluster network of claim 1, wherein the step of selecting an application to be assigned a failover node comprises the step of selecting the application that has the highest usage requirements among the applications of the node.

3. The method for identifying a failover node for an application of a multiple node cluster network of claim 1, wherein the step of selecting an application to be assigned a failover node comprises the step of selecting the application that has the highest assigned priority among the applications of the node.

4. The method for identifying a failover node for an application of a multiple node cluster network of claim 1, wherein the step of identifying a set of nodes having usage capacity greater than the usage capacity of the selected application comprises the step of identifying those nodes that (a) have available processor usage that is greater than the processor usage requirement of the selected application; and (b) have available memory usage that is greater than the memory usage requirement of the selected application.

5. The method for identifying a failover node for an application of a multiple node cluster network of claim 4, wherein the step of selecting the node having the most usage capacity comprises the step of selecting the node that has the greatest available processor usage.

6. A method for identifying a preferred failover node for each application of a first node in a multi-node cluster network, comprising the steps of:
for each node of the network, writing, to a commonly accessible storage location, usage information concerning the usage of the node and the usage requirements of each application of the node;
making a copy of the usage information at the first node;
selecting a first application for assignment to a preferred failover node;
identifying a set of nodes in the cluster network that satisfy certain usage requirements concerning the available usage in the node versus the usage needs of the first application;
selecting a preferred failover node from among the set of identified nodes as the preferred failover node for the first application; and
updating the copy of the usage information to reflect the assignment of a preferred failover node to the first application.

7. The method for identifying a preferred failover node for each application of a first node in a multi-node cluster network of claim 6, wherein the step of writing usage information to a commonly accessible storage location comprises the step of writing the processor and memory usage of each node to a shared storage area in the cluster network.

8. The method for identifying a preferred failover node for each application of a first node in a multi-node cluster network of claim 7, wherein the step of writing usage information to a commonly accessible storage location comprises the step of writing the processor and memory requirements of each application of each node to the shared storage area of the cluster network.

9. The method for identifying a preferred failover node for each application of a first node in a multi-node cluster network of claim 6, wherein the step of selecting a first application for assignment to a preferred failover node comprises the step of selecting the application of the first node that has the highest processor utilization requirements.

10. The method for identifying a preferred failover node for each application of a first node in a multi-node cluster network of claim 6, wherein the step of selecting a first application for assignment to a preferred failover node comprises the step of selecting the application of the first node that has the highest assigned priority.

11. The method for identifying a preferred failover node for each application of a first node in a multi-node cluster network of claim 6, wherein the step of identifying a set of nodes having usage capacity greater than the usage capacity of the selected application comprises the step of selecting each node that qualifies as (a) having available processing capacity that is greater than the processor requirements of the selected application; and (b) having available memory capacity that is greater than the memory requirements of the selected application.

12. The method for identifying a preferred failover node for each application of a first node in a multi-node cluster network of claim 11, wherein the step of selecting a preferred failover node from among the set of identified nodes as the preferred failover node for the first application comprises the step of selecting, from among the set of identified nodes, the node that has the most available processing capacity.

13. The method for identifying a preferred failover node for each application of a first node in a multi-node cluster network of claim 8,
wherein the step of identifying a set of nodes having usage capacity greater than the usage capacity of the selected application comprises the step of selecting each node that qualifies as (a) having available processing capacity that is greater than the processor requirements of the selected application; and (b) having available memory capacity that is greater than the memory requirements of the selected application; and
wherein the step of selecting a preferred failover node from among the set of identified nodes as the preferred failover node for the first application comprises the step of selecting, from among the set of identified nodes, the node that has the most available processing capacity.

14. The method for identifying a preferred failover node for each application of a first node in a multi-node cluster network of claim 13, wherein the step of updating the copy of the usage information to reflect the assignment of a preferred failover node to the first application comprises the step of updating the copy of the usage information to reflect the addition of the current processor usage of the selected application to the processor usage of the assigned preferred failover node.

15. The method for identifying a preferred failover node for each application of a first node in a multi-node cluster network of claim 14, wherein the step of updating the copy of the usage information to reflect the assignment of a preferred failover node to the first application comprises the step of updating the copy of the usage information to reflect the addition of the current memory usage of the selected application to the memory usage of the assigned preferred failover node.

16. The method for identifying a preferred failover node for each application of a first node in a multi-node cluster network of claim 6, further comprising the step of selecting a second application in the first node for assignment of a preferred failover node, wherein the preferred failover node for the second application is based on the updated copy of the usage information.

17. The method for identifying a preferred failover node for each application of a first node in a multi-node cluster network of claim 16, wherein the step of selecting a second application in the first node for assignment of a preferred failover node comprises the step of selecting the application of the first node that has the highest processor requirements among those that have not yet been assigned to a preferred failover node.

18. The method for identifying a preferred failover node for each application of a first node in a multi-node cluster network of claim 16, wherein the step of selecting a second application in the first node for assignment of a preferred failover node comprises the step of selecting the application of the first node that has the highest assigned priority among those that have not yet been assigned to a preferred failover node.

19. The method for identifying a preferred failover node for each application of a first node in a multi-node cluster network of claim 6, further comprising the step of, for each node of the cluster network, periodically writing, to the commonly accessible storage location, usage information concerning the current usage of the node and the current usage requirements of each application of the node.

20. A cluster network, comprising:
a first node having at least one application running thereon;
a second node having at least one application running thereon;
a third node having at least one application running thereon;
shared storage accessible by each of the nodes, wherein the shared storage includes a table reflecting the processor usage and memory usage of each node and the processor requirements and memory requirements of each application of the nodes;
wherein each node includes a management module for assigning failover nodes to each application of each node, wherein each management module is operable to:
retrieve the table from shared storage;
identify a first application for assignment of a preferred failover node;
select a preferred failover node for the first application on the basis of the processor requirements and memory requirements of the first application and the available processor resources and available memory resources of the nodes of the cluster network;

21. The cluster network of claim 20, wherein each node is operable to periodically write to the table in shared storage the current processor usage and memory usage of the node and the processor requirements and memory requirements of each application of the node.

22. The cluster network of claim 21, wherein the management module of each node is operable to update the retrieved table following the assignment of a preferred failover node to an application to reflect the reduced processor availability and memory availability in the preferred failover node.

23. The cluster network of claim 22, wherein the management module of each node is operable to assign a preferred failover node to a second application, and wherein the assignment of the preferred failover node to the second application is based, in part, on the updated content of the retrieved table.
